(19) United States
(12) Patent Application Publication
(10) Pub. No.: US 2026/0197256 A1
(43) Pub. Date: Jul. 9, 2026

(54) Network Management System Automation Command Execution Tool

(71) Applicant: T-Mobile Innovations LLC, Overland Park, KS (US)

(72) Inventors: Miguel Angel Villavicencio BETANCOURT, Ocoee, FL (US); Dat HO, Orlando, FL (US); Chris POIRIER, Titusville, FL (US)

(21) Appl. No.: 19/011,487

(22) Filed: Jan. 6, 2025

(51) Int. Cl. H04L 41/22

(52) U.S. Cl. CPC H04L 41/22

(57) ABSTRACT

A method of maintaining a wireless network. The method comprises receiving a first request associated with a cell site from a network management system (NMS) interface by an NMS application, wherein the first request identifies a first command that is a service affecting command type; based on the first request, invoking a first command by the NMS application on a real-time command engine that executes on a computer; receiving a second request associated with the cell site from the NMS interface, wherein the second request identifies a second command that is a service affecting command type; determining by the NMS application that the first command has not completed executing; and based on the determination that the first command has not completed executing, returning an error to the NMS user interface indicating that two service affecting commands cannot be executed on the same cell site at the same time.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND

Communication network operators build systems and tools to monitor their networks, to identify network elements (NE) that need maintenance, to assign maintenance tasks to personnel, and to fix network elements. Operational support systems (OSSs) may be provided by vendors of NEs to monitor and maintain their products. When trouble occurs in NEs, the OSS and/or the NEs may generate an alarm notification. An incident reporting system may be provided by the network operator to track incident reports which may be assigned to employees resolve one or more pending alarms. A network operation center (NOC) may provide a variety of workstations and tools for NOC personnel to monitor alarms, close incident reports, and maintain the network as a whole. It is understood that operating and maintaining a nationwide communication network comprising tens of thousands of cell sites and other NEs is very complicated.

### SUMMARY

In an embodiment, a method of maintaining a wireless communication network is disclosed. The method comprises receiving a first selection of a wireless communication equipment item by a network management system (NMS) user interface executing on a computer system; determining a context of a user of the NMS user interface by an NMS application executing on a computer system based on the first selection of the wireless communication equipment item; determining by the NMS application a list of NMS commands that are allowed to the user of the NMS user interface based on the context of the NMS user; and sending the list of allowed NMS commands by the NMS application to the NMS user interface. The method further comprises receiving a first selection of one of the allowed NMS commands by the NMS application from the NMS user interface; mapping the first selected NMS command by the NMS application to a real-time command engine application executing on a computer; and invoking the first selected NMS command on the real-time command engine application by the NMS application. The method further comprises receiving results of the first selected NMS command by the NMS application from the real-time command engine application; formatting the results of the first selected NMS command by the NMS application; and sending the formatted results of the first selected NMS command by the NMS application to the NMS user interface, whereby a network management task is completed by a user of the NMS user interface.

In another embodiment, a method of maintaining a wireless network is disclosed. The method comprises receiving a first request associated with a cell site from a network management system (NMS) interface executing on a computer system by an NMS application executing on a computer system, wherein the first request identifies a first command that is a service affecting command type and, based on the first request, invoking the first command by the NMS application on a real-time command engine that executes on a computer. The method further comprises receiving a second request associated with the cell site from the NMS interface, wherein the second request identifies a second command that is a service affecting command type; determining by the NMS application that the first command has not completed executing; and based on the determination that the first command has not completed executing, returning an error to the NMS user interface indicating that two service affecting commands cannot be executed on the same cell site at the same time.

In yet another embodiment, a method of maintaining a wireless network is disclosed. The method comprises generating a list of allowable commands by a network management system (NMS) application executing on a computer based on a context of a user associated with a wireless communication service provider; receiving a selection of a first command of one of the allowable commands by the NMS application, wherein the first command is a service affecting type of command and the first command is directed to a first node of the wireless network; and invoking the first command by the NMS application on a real-time command engine that executes on a computer. The method further comprises receiving a selection of a second command of one of the allowable commands by the NMS application, wherein the second command is a service affecting type of command and the second command is directed to the first node of the wireless network; determining by the NMS application that the first command has not completed executing; and based on the determination that the first command has not completed executing, returning an error to a NMS user interface indicating that two service affecting commands cannot be executed on the same network node at the same time.

In yet another embodiment, a system for maintaining a wireless communication network is disclosed. The system comprises an at least one processor, a non-transitory memory, a display, a real-time command engine stored in the non-transitory memory, a user interface application stored in the non-transitory memory, and a network management system (NMS) application stored in the non-transitory memory. The real-time command engine, when executed by the at least one processor, executes real-time commands. The user interface application, when executed by the at least one processor, receives inputs and transmits outputs to the display. The NMS application, when executed by the at least one processor, receives a selection of a first command from the user interface application, responsive to the first command, executes a first script that completes a test determining a state of a communication link between two equipment cabinets at a cell site in the wireless communication network, and returns a result of the first command to the user interface application. The NMS application further receives a selection of a second command from the user interface application, responsive to the second command, executes a second script that completes a test determining a state of a connection of fiber optic cables at a second cell site in the wireless communication network, and returns a result of the second command to the user interface application. The NMS application further receives a selection of a third command from the user interface application, invokes the third command on the real-time command engine, receives a result of the third command from the real-time command engine, and returns the result of the third command to the user interface application. The user interface application further presents the result of the first command, the result of the second command, and the result of the third command on the display.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2A is a message sequence diagram of a first command execution according to an embodiment of the disclosure.

FIG. 2B is a message sequence diagram of a second command execution according to another embodiment of the disclosure.

FIG. 3A and FIG. 3B are a flow chart of a method according to an embodiment of the disclosure.

FIG. 4 is a flow chart of another method according to an embodiment of the disclosure.

FIG. 5A and FIG. 5B are a block diagram of a communication system according to an embodiment of the disclosure.

FIG. 6 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A network management system (NMS) automation execution tool is disclosed herein. In the past, workers of a wireless communication service provider may have executed commands to monitor and maintain radio access network (RAN) equipment one at a time, constituting a farrago of unrelated commands. Workers would need to learn many different commands that may not have shared similar invocation arguments. Different commands or tasks may have entailed a plurality of different steps, possibly involving “swivel seat” operations where the worker would have to manually interact with a plurality of different software tools to achieve a single maintenance task. The NMS automation execution tool taught herein is a particular technical solution to the technical problem of monitoring and maintaining a complex wireless communication network.

The NMS automation execution tool comprises an NMS application that executes on a computer system. In an embodiment, an NMS interface is presented to users (e.g., workers or technicians) at a network operations center (NOC) via a NOC dashboard. The NOC dashboard may be provided as an application that different NOC users can access through their own workstations concurrently. The NOC dashboard may provide access to a variety of other software tools used by users to monitor and manage the RAN. The NOC dashboard may allow users to select RAN equipment from a cell site inventory, such that the user can determine a current status of selected RAN equipment. The NMS interface may send a request for a list of available commands to the NMS application. The NMS interface sends a context of a particular user along with the request for the list of available commands that indicates who the user is and/or what privilege or role is associated with the user and that indicates what item of RAN equipment the user is currently examining via the NOC dashboard. This information included with the request for the list of available commands may generally be referred to as a user context. In an embodiment, the user context may be sent in the form of a JSON object including one or more key-value pairs.

The NMS application receives the user context and identifies all commands that are valid given the specified user context. For example, if the user is viewing an equipment cabinet rack via the NOC dashboard, a command to adjust an antenna tilt angle may not be valid or sensible. For example, if the user is an entry level technician, a command to increase a radio transmission power level may not be allowed. For example, if a service affecting command is currently being executed by a different user, another service affecting command may not be allowed. The commands that are valid and/or allowed are formatted into a list by the NMS application and returned to the NMS interface. The NMS interface presents the list of available commands in a display of the NOC dashboard. This function of providing a list of only the commands that are available can save time of users by preventing them attempting to execute a command only to have it fail. Additionally, this function of providing a list of only the commands that are available can increase security of the system as a whole and prevent undesired execution of commands by users who are not authorized to execute such commands.

When the user clicks on a command that is listed in the display on the NOC dashboard, the NMS interface sends the selection to the NMS application. The NMS application then determines or maps what needs to be done to execute the given command. In some cases, a command may involve running a script by the NMS application. The script executed by the NMS application may involve multiple separate steps and may entail accessing a plurality of separate systems in a wireless communication service provider domain - for example one or more data bases, a maintenance activity tracking tool, one or more operational support systems (OSSs), and a network node and/or cell site. In other cases, the NMS application may hand off execution of the selected command to a real-time command engine (RTCE). After the command has completed, the NMS application determines a result, formats information associated with that result, and sends the formatted result back to the NMS interface. The NMS interface presents the results of the command in a display to the user.

The NMS automation execution tool provides a specific technical solution to the technical problem of maintaining a nation-wide cellular communication network. The NMS automation execution tool described herein provides increased convenience, efficiency, and security. The NMS automation execution tool may reach out to a plurality of separate sources of information and or data, for example, databases, maintenance tracking tool, one or more OSS, and a network node or cell site to filter and/or confirm what commands or access operations the given user can invoke. The NMS automation execution tool cross-checks among a plurality of users concurrently using the tool to avoid users stepping on each other's toes or interfering with each other. The NMS automation execution tool supports extensibility as new generations of telecommunication protocols are brought into service, because the same framework can be used. In this case, new commands are experienced as new commands available to the user of the NOC dashboard, while the NMS application hides any new complications from the users.

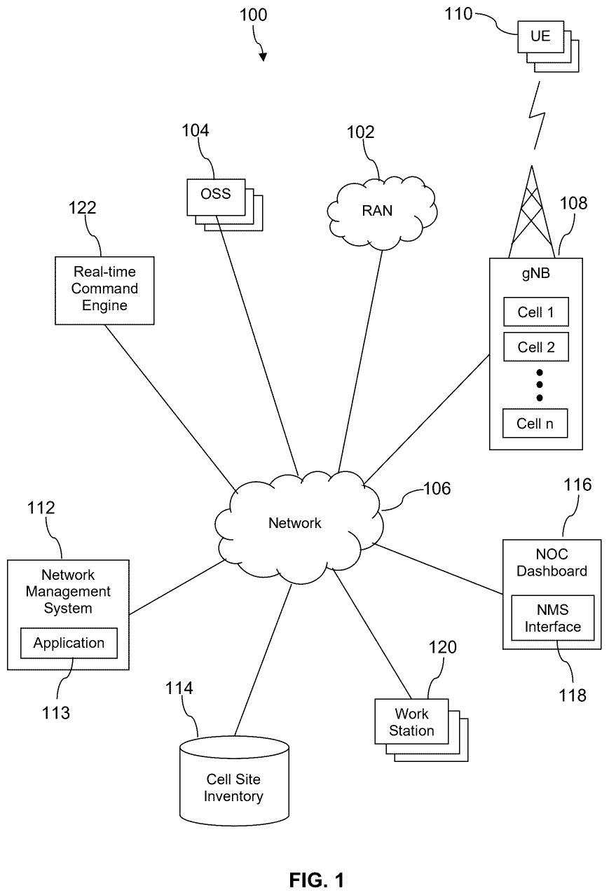

Turning now to FIG. 1, a system 100 is described. In an embodiment, system 100 comprises a radio access network (RAN), one or more operational support systems (OSSs) 104, a network 106, and a cell site 108. The cell site 108 may provide wireless communication links to user equipments (UEs) 110. It is understood that the cell site 108 may be considered to be part of the RAN 102 but is shown separately in FIG. 1 for improved understanding. While only a single cell site 108 is illustrated in FIG. 1, it is understood that the system 100 may include tens of thousands or even hundreds of thousands of cell sites 108. The cell site 108 may comprise one or more separate cells. The cells may provide wireless communication links to UEs 110 according to a 6G, a 5G, a long-term evolution (LTE), a code division multiple access (CDMA), a universal mobile telecommunications service (UMTS), or global system for mobile communications (GSM) telecommunication protocol. It is understood that different cells at the same cell site 108 may provide wireless communication links according to the same telecommunication protocol or according to different telecommunication protocols.

The network 106 comprises one or more public networks, one or more private networks, or a combination thereof. The UEs 110 may include a mix of different kinds of devices, including cell phones, mobile phones, smart phones, wearable computers, headset computers, laptop computers, notebook computers, tablet computers, and/or Internet of things (IoT) devices. Each of the OSSs 104 may comprise a computer that executes an application that promotes communicating with equipment in the RAN 102 including equipment in the cell site 108. Computers are described further hereinafter. The OSSs 104 may be provided by vendors of equipment in the RAN 102, for example vendors of equipment at the cell site 108, to promote a wireless communication service provider maintaining equipment.

The system 100 further comprises a network management system (NMS) 112. In an embodiment, the NMS 112 comprises a computer system that executes an NMS application 113. The NMS application 113 communicates via the network 106 with the OSSs 104 and with a cell site inventory 114 and a network operation center (NOC) dashboard 116. The NOC dashboard 116 executes an NMS interface 118 that provides an application programming interface to the NMS application 113. In an embodiment, the NMS application 113 may execute on the same computer system that executes the NOC dashboard 116 and the NMS interface 118. In another embodiment, however, the NMS application 113 executes on a computer system that is different from the computer system that executes the NOC dashboard 116 and the NMS interface 118.

The system 100 further comprises a real-time command engine (RTCE) 122. The RTCE 122 may be an application that executes on a computers system 122 that is the same computer system that the NOC dashboard 116 executes on or a different computer system. The RTCE 122 may execute commands that work via the OSS 104 to access current information from equipment of the RAN 102, for example current information from the equipment of the cell site 108 or to trigger actions on the equipment of the RAN 102, for example trigger actions on the cell site 108. The RTCE 122 may know or look-up passwords for accessing the OSSs 104 and/or to trigger actions on the equipment of the RAN 102. The RTCE 122 commands may obtain current status of equipment in the RAN 102 and/or equipment at the cell site 108. The RTCE 122 commands may retrieve alarms from the equipment in the RAN 102 and/or equipment at the cell site 108. The RTCE 122 commands can execute service affecting or service impacting commands on the equipment of the RAN 102 and/or equipment of the cell site 108, for example triggering equipment resets, equipment locks, equipment unlocks. A service affecting command is likely to affect communication service provided by the cell site 108, for example reducing the number of subscribers that may be served concurrently by the cell site 108, reducing the data throughput rates that may be provided to subscribers concurrently, causing some on-going subscriber calls to drop, interrupting backhaul provided by the cell site 108 to other cell sites (in the instance the cell site 108 is a donor site that provides backhaul connectivity to the other cell site), and other like diminishment of efficiency or throughput. The RTCE 122 commands may include bundled commands, wherein a plurality of separate commands may be executed in a pre-defined sequence on equipment in the RAN 102 and/or on the equipment at the cell site 108.

NOC workers and/or NOC technicians can interact with the NOC dashboard 116 via one or more workstations 120. Thus, individual NOC technicians may interact with an instance of the NOC dashboard 116 on their own workstation 120 to monitor and maintain the RAN 102 and the cell sites 108. The NOC dashboard 116 interacts with the NMS interface 118 to obtain and present a list of commands that a NOC technician can execute. Once listed, the NOC technician can, via a workstation 120, trigger execution of one of the commands, receive a result, and see the results presented on a display of the workstation 120. Some of the commands listed on the NOC dashboard 116 can be directed to providing monitoring or diagnostic information. Some of the commands listed on the NOC dashboard 116 can be directed to initiating maintenance actions on equipment of the RAN 102, for example initiate maintenance actions on the cell site 108. The NMS application 113 may execute some of the commands itself, for example executing a script that works via the OSSs 104 to monitor and perform diagnostics on the equipment of the RAN 102 and/or the equipment of the cell site 108. For more details on scripts that the NMS application 113 may execute, see U.S. patent application Ser. No. 18/977,810 filed Dec. 11, 2024 titled “Wireless Network Cell Audit Tools” by Jamir A. Dirksen et al, which is hereby incorporated by reference in its entirety.

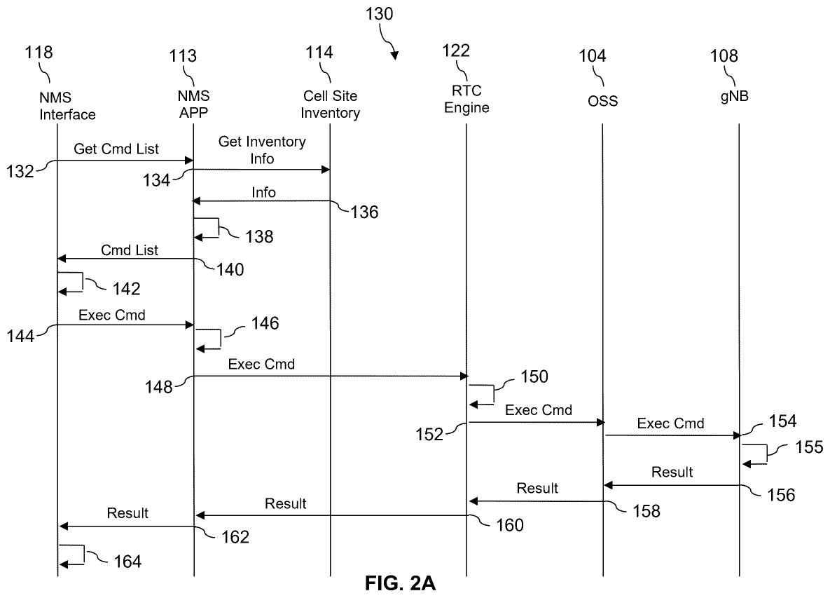

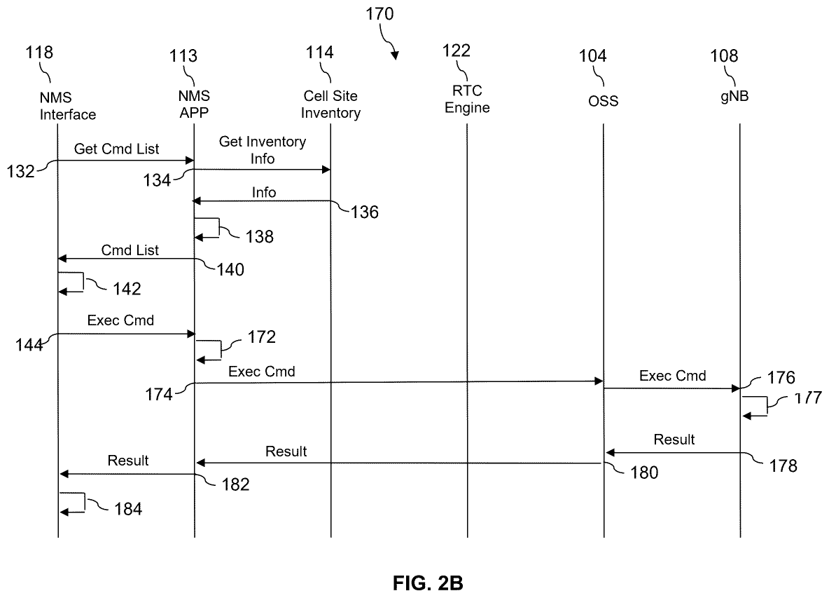

Turning now to FIG. 2A, a first message sequence 130 is described. In an embodiment, the first message sequence 130 relates to a process that involves executing a command by the RTCE 122. The NMS interface 118 sends a first message 132 to get a command list to the NMS application 113. The first message 132 comprises context related to a user that is accessing the NOC dashboard 116, for example via a workstation 120. The context may identify one or more inventory items that the user is monitoring via the NOC dashboard 116, for example a specific cell site 108, a specific cell within the cell site 108, a specific equipment cabinet, a specific antenna element, a specific radio frequency (RF) amplifier, a specific circuit card, a specific backhaul router, a specific grid power status indicator, a specific battery backup equipment item, a specific backup generator equipment item, or other equipment items. The context may identify the user and/or a role or privilege associated with the user. In embodiment, the user content carried with the first message 132 is contained in a JSON object comprising one or more key-value pairs.

The NMS application 113 responds to the first message 132 by sending a second message 134 to get inventory information from the cell site inventory data store 114. The second message 134 may identify one or more RAN equipment items, based on the user context received in the first message 132. The cell site inventory data store 114 returns a third message 136 comprising the requested inventory information. At block 138, the NMS application 113 analyzes the user context received in the first message 132 and the information returned from the cell site inventory data store 114 to identify what commands are available to the user via the NMS interface 118 for execution. At block 138, the NMS application 113 determines a command list to be returned to the NMS interface 118. Some commands may not be meaningful given the user context and may be omitted from the command list, for example if the user is monitoring a radio head of the cell site 108, commands related to the grid power, battery backup, and generator backup may be irrelevant and hence omitted from the command list. Some comments may not be authorized for invocation by the user or user privilege identified in the user context, for example a first level NOC technician may not be authorized to execute a service affecting command, and hence serve affecting commands may be omitted from the command list. The NMS application 113 sends a fourth message 140 that contains the command list produced by the NMS application at block 138 to the NMS interface 118.

At block 142, the NMS interface 118 may present the command list in a display of the NOC dashboard 116 to the user. The command list may be presented in a scrollable list in a graphical user interface (GUI) presented within the NOC dashboard 116 display. The processing of block 142 may also entail the NMS interface 118 receiving a selection of one of the commands in the command list. In response to receiving a selection of a command from the command list, the NMS interface sends a fifth message 144 to execute the selected command to the NMS application 113. The fifth message 144 identifies an item of equipment that is the target of the selected command. At block 146, the NMS application 113 determines that the selected command is a command that is to be executed by the RTCE 122 and sends a sixth message 148 to execute the selected command to the RTCE 122. The sixth message 148 identifies the command to be executed and the item of equipment that is the target of the selected command.

At block 150, the RTCE 122 responds to receipt of the sixth message 148 by performing some preliminary tasks. For example, the RTCE 122 may look-up an address or other designation of an OSS 104 associated with the equipment identified in the selected command. Alternatively, however, the sixth message 148 sent by the NMS app 113 may include the address or other designation of the OSS 104 associated with the equipment identified in the selected command. For example, the RTCE 122 may look-up login credentials for the subject OSS 104. Alternatively, the sixth message 148 may include login credentials for the subject OSS 104. The RTCE 122 at block 150 may establish a secure shell (SSH) session with the subject OSS 104 using the login credentials. The RTCE 122 sends a seventh message 152 to the subject OSS 104 to execute the selected command on the equipment. The OSS sends an eighth message 154 to the cell site 108 to execute the selected command.

At block 155, the cell site 108 and/or an equipment item identified in the selected command may execute the given command. The cell site 108 returns a ninth message 156 including a response to the command to the OSS 104. The OSS 104 sends a tenth message 158 including the response to the RTCE 122. The RTCE 122 sends an eleventh message 160 including the response to the NMS application 113. The NMS application 113 sends a twelfth message 162 including the response to the NMS interface 118.

At block 164, the NMS interface 118 presents information about the result of the selected command to the user, for example presents a success or failure message on a display of the workstation 120 and/or of the NOC dashboard 116.

Turning now to FIG. 2B, a second message sequence 170 is described. The main difference between second message sequence 170 and first message sequence 130 is that the second message sequence 170 pertains to a command that can be invoked on the OSS 104 by the NMS application 113 without involving the RTCE 122. The messages 132, 134, 136, 140, and 144 and processing blocks 138, 142 are substantially similar to the corresponding messages and processing blocks in the first message sequence 130 described above with reference to FIG. 2A. At block 172, the NMS application 113 determines that the selected command is a command that the NMS application 113 can itself invoke on the OSS 104 without the intervention of the RTCE 122. At block 172, the NMS application 113 may perform some preliminary tasks. For example, at block 172, the NMS application 113 may look-up an address or other designation of an OSS 104 associated with the equipment identified in the selected command. For example, at block 172, the NMS application 113 may look-up login credentials for the subject OSS 104. The NMS application 113 may initiate an SSH session with the subject OSS 104 using the logic credentials. The NMS application 113 sends a thirteenth message 174 to the appropriate OSS 104.

The OSS 104 sends a fourteenth message 176 to the cell site 108 to execute the selected command. At block 177, the cell site 108 and/or an equipment item identified in the selected command may execute the given command. The cell site 108 returns a fifteenth message 178 including a response to the command to the OSS 104. The OSS 104 sends a sixteenth message 180 including the response to the NMS application 113. The NMS application 113 sends a seventeenth message 182 including the response to the NMS interface 118.

At block 184, the NMS interface 118 presents information about the result of the selected command to the user, for example presents a success or failure message on a display of the workstation 120 and/or of the NOC dashboard 116.

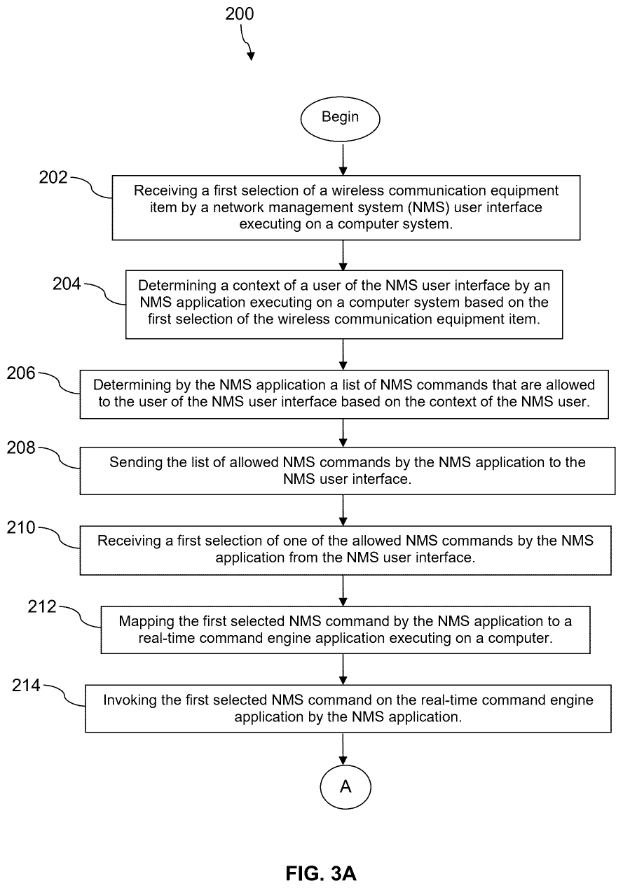

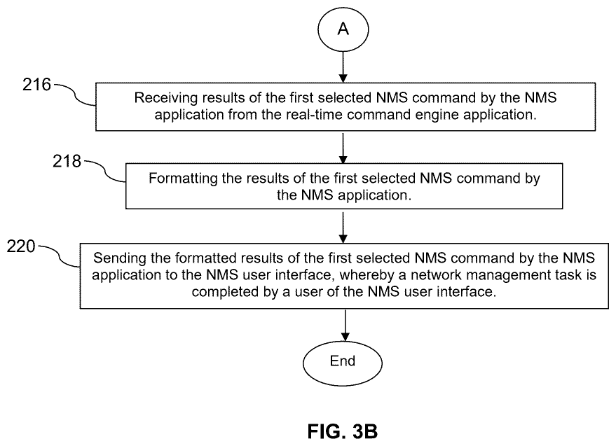

Turning now to FIG. 3A and FIG. 3B, a method 200 is described. In an embodiment, the method 200 is a method of maintaining a wireless communication network. At block 202, the method 200 comprises receiving a first selection of a wireless communication equipment item by a network management system (NMS) user interface executing on a computer system. In an embodiment, the NMS user interface sends the first selection of the wireless communication equipment item and an identity of the user to the NMS application in a JSON object comprising a plurality of key-value pairs. In an embodiment, the first selection of a wireless communication equipment item is a cell site, is a cell, is an equipment cabinet, is a rack of circuit cards, is a circuit card, is a backhaul router, is a grid electrical power monitor, is a battery backup, is an antenna angle positioner, or a radio frequency power amplifier.

At block 204, the method 200 comprises determining a context of a user of the NMS user interface by an NMS application executing on a computer system based on the first selection of the wireless network equipment item. At block 206, the method 200 comprises determining by the NMS application a list of NMS commands that are allowed to the user of the NMS user interface based on the context of the NMS user. At block 208, the method 200 comprises sending the list of allowed NMS commands by the NMS application to the NMS user interface.

At block 210, the method 200 comprises receiving a first selection of one of the allowed NMS commands by the NMS application from the NMS user interface. At block 212, the method 200 comprises mapping the first selected NMS command by the NMS application to a real-time command engine application executing on a computer. At block 214, the method 200 comprises invoking the first selected NMS command on the real-time command engine application by the NMS application.

At block 216, the method 200 comprises receiving results of the first selected NMS command by the NMS application from the real-time command engine application. At block 218, the method 200 comprises formatting the results of the first selected NMS command by the NMS application. At block 220, the method 200 comprises sending the formatted results of the first selected NMS command by the NMS application to the NMS user interface, whereby a network management task is completed by a user of the NMS user interface.

In an embodiment, the method 200 further comprises receiving a second selection of one of the allowed NMS commands by the NMS application from the NMS user interface; mapping the second selected NMS command by the NMS application to a command to diagnose a condition of a communication link between two equipment cabinets associated with a same cell at a cell site; invoking the second selected NMS command on the cell site by the NMS application; receiving results of the second selected NMS command by the NMS application from the cell site; formatting the results of the second selected NMS command by the NMS application; and sending the formatted results of the second selected NMS command by the NMS application to the NMS user interface.

In an embodiment, the method 200 further comprises receiving a third selection of one of the allowed NMS commands by the NMS application from the NMS user interface; mapping the third selected NMS command by the NMS application to a command to diagnose a condition of a pair of fiber optic cables connecting an equipment rack at a cell site to an antenna sector at the cell site; invoking the third selected NMS command on the cell site by the NMS application; receiving results of the third selected NMS command by the NMS application from the cell site; formatting the results of the third selected NMS command by the NMS application; and sending the formatted results of the third selected NMS command by the NMS application to the NMS user interface.

In an embodiment, the first selected NMS command is a service affecting command and the method 200 further comprises receiving a fourth selection of one of the allowed NMS commands by the NMS application from the NMS user interface, wherein the fourth selected NMS command is a service affecting NMS command; determining by the NMS application that the first selected NMS command is on-going; and responsive to determining that the first selected NMS command is on-going, sending a notification by the NMS application to the NMS user interface indicating that the fourth selected NMS command cannot be executed because it is a service affecting NMS command, indicating that another service affecting NMS command is on-going at the cell site associated with the first selected wireless communication equipment item, and indicating that it is unauthorized to execute two service affecting NMS commands at the same time at the same cell site.

In an embodiment, the first selected NMS command is a service affecting command and the method 200 further comprises receiving a second selection of a wireless communication equipment item by the NMS user interface from a second user, wherein the first selected wireless communication equipment item and the second selected wireless communication equipment item are located at the same cell site; determining a context of the second user of the NMS user interface by the NMS application based on the second selection of the wireless communication equipment item; developing by the NMS application a second list of NMS commands that are allowed to the second user of the NMS user interface based on the context of the second NMS user; sending the second list of allowed NMS commands by the NMS application to the NMS user interface; receiving a fifth selection of one of the second list of allowed NMS commands by the NMS application from the NMS user interface, wherein the fifth selected NMS command is a service affecting NMS command; determining by the NMS application that the first selected NMS command is on-going; and responsive to determining that the first selected NMS command is on-going, sending a notification by the NMS application to the NMS user interface indicating that the fifth selected NMS command cannot be executed because it is a service affecting NMS command, indicating that another service affecting NMS command is on-going at the cell site associated with the second selected wireless communication equipment item, and indicating that it is unauthorized to execute two service affecting NMS commands at the same time at the same cell site.

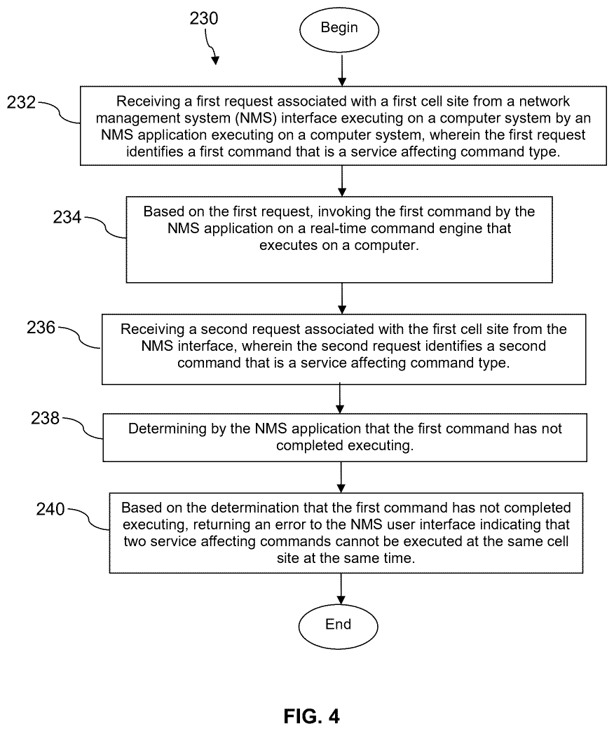

Turning now to FIG. 4, a method 230 is described. In an embodiment, the method 230 is a method of maintaining a wireless network. At block 232, the method 230 comprises receiving a first request associated with a cell site from a network management system (NMS) interface executing on a computer system by an NMS application executing on a computer system, wherein the first request identifies a first command that is a service affecting command type. At block 234, the method 230 comprises, based on the first request, invoking a first command by the NMS application on a real-time command engine that executes on a computer.

At block 236, the method 230 comprises receiving a second request associated with the cell site from the NMS interface, wherein the second request identifies a second command that is a service affecting command type. At block 238, the method 230 comprises determining by the NMS application that the first command has not completed executing. At block 240, the method 230 comprises, based on the determination that the first command has not completed executing, returning an error to the NMS user interface indicating that two service affecting commands cannot be executed on the same cell site at the same time.

In an embodiment, a first user is associated with the first request and a second user is associated with the second request. In an embodiment, the method 230 further comprises generating a list of allowable commands by the NMS application based on a context of a user associated with the first request and based on a wireless network equipment item identified in the first request; and presenting the list of allowable commands by the NMS interface on a network operation center (NOC) dashboard, wherein the first command is one of the listed allowable commands. In an embodiment, the context of the user comprises an identity of the user, a role associated with the user, an identity of a cell site equipment item being presented in the NMS interface viewed by the user, and a status of the cell site equipment item being presented in the NMS interface viewed by the user. The status of the cell site equipment item can include a maintenance mode of the cell site equipment item. The status of the cell site equipment item can include an indication that another user (a different user) is also viewing the cell site equipment item. The status of the cell site equipment item can include an indication that another service affecting command is being performed on the cell site equipment item or on another item of cell site equipment at the same cell site.

In an embodiment, the cell site provides wireless communication links to wireless communication service subscriber user devices according to a 6G, a 5G, a long-term evolution (LTE), a code division multiple access (CDMA), a universal mobile phone service (UMTS), or a global system for mobile communications (GSM) telecommunication protocol. In an embodiment, the wireless communication service subscriber user devices are any mix of smart phones, wearable computers, headset computers, laptop computers, notebook computers, tablet computers, or Internet of things (IoT) devices.

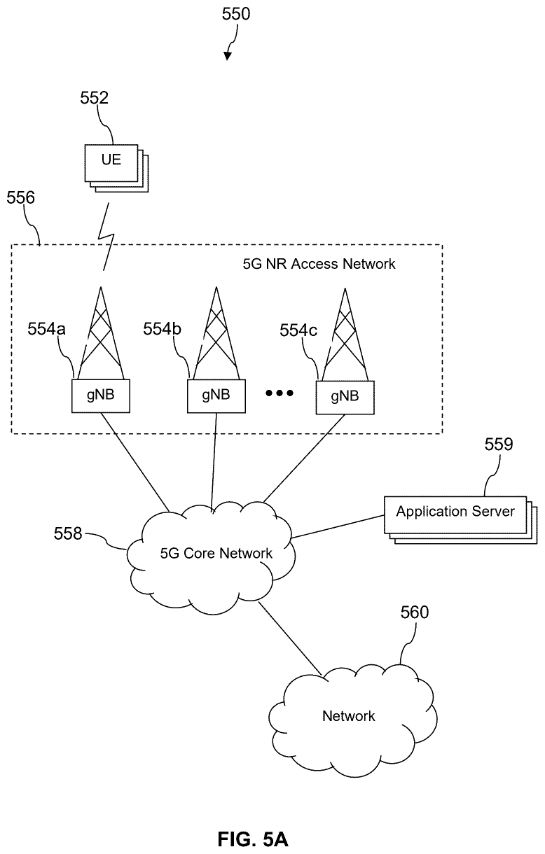

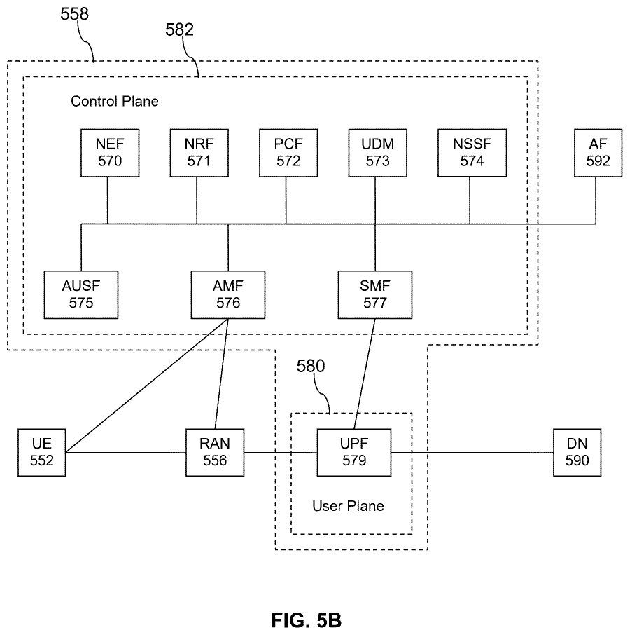

Turning now to FIG. 5A, an exemplary communication system 550 is described. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., long-term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long-Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 5B, further details of the core network 558 are described. In an embodiment, the core network 558 is a 5G core network. 5G core network technology is based on a service-based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 5A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow-based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

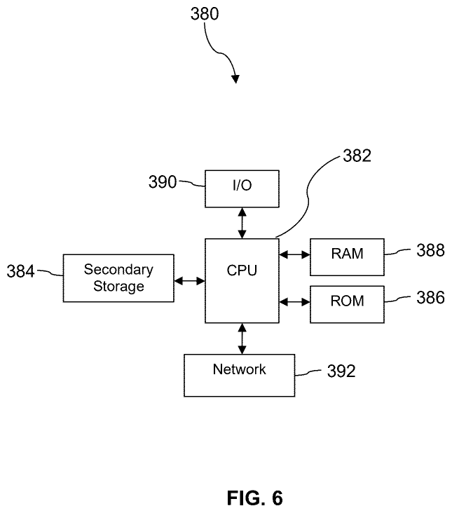

FIG. 6 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system for maintaining a wireless communication network comprising:
an at least one processor;
a non-transitory memory;
a display;
a real-time command engine stored in the non-transitory memory that, when executed by the at least one processor, executes real-time commands;
a user interface application stored in the non-transitory memory that, when executed by the at least one processor, receives inputs and transmits outputs to the display; and
a network management system (NMS) application stored in the non-transitory memory that, when executed by the at least one processor:
receives a selection of a first command from the user interface application,
responsive to the first command, executes a first script that completes a test determining a state of a communication link between two equipment cabinets at a cell site in the wireless communication network,
returns a result of the first command to the user interface application,
receives a selection of a second command from the user interface application,
responsive to the second command, executes a second script that completes a test determining a state of a connection of fiber optic cables at a second cell site in the wireless communication network,
returns a result of the second command to the user interface application,
receives a selection of a third command from the user interface application,
invokes the third command on the real-time command engine,
receives a result of the third command from the real-time command engine, and
returns the result of the third command to the user interface application;
wherein the user interface application presents the result of the first command, the result of the second command, and the result of the third command on the display.

2. The system of claim 1, wherein the user interface application sends a JSON object comprising a plurality of key-value pairs to the NMS application, wherein the JSON object defines a context of a user that selects the first command.

3. The system of claim 2, wherein the NMS application determines a list of commands that are allowed to the user that selects the first command based on the JSON object and sends the list of allowed commands to the user interface application, wherein the first command is among the list of allowed commands.

4. The system of claim 2, wherein the third command retrieves an alarm from an item of equipment at a cell site, triggers a reset of an item of equipment at a cell site, or triggers execution of a bundled command.

5. The system of claim 1, wherein the NMS application further:
executes a fourth command on the real-time command engine, wherein the fourth command is a service affecting command type;
receives a selection of a fifth command from the user interface application, wherein the fifth command is a service affecting command type;
in response to receiving the selection of the fifth command, determines that the fourth command has not completed execution; and
sends an error message to the user interface application indicating that two service affecting commands cannot be executed on the same cell site at the same time.

6. The system of claim 5, wherein the fourth command is associated with a first user of the user interface application and wherein the fifth command is associated with a second user of the user interface application.

7. A method of maintaining a wireless network, comprising:
receiving a first request associated with a cell site from a network management system (NMS) interface executing on a computer system by an NMS application executing on a computer system, wherein the first request identifies a first command that is a service affecting command type;
based on the first request, invoking the first command by the NMS application on a real-time command engine that executes on a computer;
receiving a second request associated with the cell site from the NMS interface, wherein the second request identifies a second command that is a service affecting command type;
determining by the NMS application that the first command has not completed executing; and
based on the determination that the first command has not completed executing, returning an error message to the NMS user interface indicating that two service affecting commands cannot be executed on the same cell site at the same time.

8. The method of claim 7, further comprising:
generating a list of allowable commands by the NMS application based on a context of a user associated with the first request and based on a wireless network equipment item identified in the first request; and
presenting the list of allowable commands by the NMS interface on a network operation center (NOC) dashboard, wherein the first command is one of the listed allowable commands.

9. The method of claim 8, wherein the context of the user comprises an identity of the user, a role associated with the user, an identity of a cell site equipment item being presented in the NMS interface viewed by the user, and a status of the cell site equipment item being presented in the NMS interface viewed by the user.

10. The method of claim 7, wherein a first user is associated with the first request and a second user is associated with the second request.

11. The method of claim 7, wherein the cell site provides wireless communication links to wireless communication service subscriber user devices according to a 6G, a 5G, a long-term evolution (LTE), a code division multiple access (CDMA), a universal mobile phone service (UMTS), or a global system for mobile communications (GSM) telecommunication protocol and wherein the wireless communication service subscriber user devices are any mix of smart phones, wearable computers, headset computers, laptop computers, notebook computers, tablet computers, or Internet of things (IoT) devices.

12. A method of maintaining a wireless communication network, comprising:
receiving a first selection of a wireless communication equipment item by a network management system (NMS) user interface executing on a computer system;
determining a context of a user of the NMS user interface by an NMS application executing on a computer system based on the first selection of the wireless communication equipment item;
determining by the NMS application a list of NMS commands that are allowed to the user of the NMS user interface based on the context of the NMS user;
sending the list of allowed NMS commands by the NMS application to the NMS user interface;
receiving a first selection of one of the allowed NMS commands by the NMS application from the NMS user interface;
mapping the first selected NMS command by the NMS application to a real-time command engine application executing on a computer;
invoking the first selected NMS command on the real-time command engine application by the NMS application;
receiving results of the first selected NMS command by the NMS application from the real-time command engine application;
formatting the results of the first selected NMS command by the NMS application; and
sending the formatted results of the first selected NMS command by the NMS application to the NMS user interface, whereby a network management task is completed by a user of the NMS user interface.

13. The method of claim 12, wherein the first selection of wireless communication equipment item is a cell site.

14. The method of claim 12, wherein the first selection of wireless communication equipment item is one of a plurality of different cells at a cell site.

15. The method of claim 12, wherein the first selection of wireless communication equipment item is an equipment cabinet, an equipment rack, a circuit card, a backhaul router, a grid electrical power monitor, a battery backup, a generator, an antenna angle positioner, or a radio frequency power amplifier.

16. The method of claim 12, further comprising:
receiving a second selection of one of the allowed NMS commands by the NMS application from the NMS user interface;
mapping the second selected NMS command by the NMS application to a command to diagnose a condition of a communication link between two equipment cabinets associated with a same cell at a cell site;
invoking the second selected NMS command on the cell site by the NMS application;
receiving results of the second selected NMS command by the NMS application from the cell site;
formatting the results of the second selected NMS command by the NMS application; and
sending the formatted results of the second selected NMS command by the NMS application to the NMS user interface.

17. The method of claim 12, further comprising:
receiving a third selection of one of the allowed NMS commands by the NMS application from the NMS user interface;
mapping the third selected NMS command by the NMS application to a command to diagnose a condition of a pair of fiber optic cables connecting an equipment rack at a cell site to an antenna sector at the cell site;
invoking the third selected NMS command on the cell site by the NMS application;
receiving results of the third selected NMS command by the NMS application from the cell site;
formatting the results of the third selected NMS command by the NMS application; and
sending the formatted results of the third selected NMS command by the NMS application to the NMS user interface.

18. The method of claim 12, wherein the first selected NMS command is a service affecting command and further comprising:
receiving a fourth selection of one of the allowed NMS commands by the NMS application from the NMS user interface, wherein the fourth selected NMS command is a service affecting NMS command;
determining by the NMS application that the first selected NMS command is on-going; and
responsive to determining that the first selected NMS command is on-going, sending a notification by the NMS application to the NMS user interface indicating that the fourth selected NMS command cannot be executed because it is a service affecting NMS command, indicating that another service affecting NMS command is on-going at the cell site associated with the first selected wireless communication equipment item, and indicating that it is unauthorized to execute two service affecting NMS commands at the same time at the same cell site.

19. The method of claim 12, wherein the first selected NMS command is a service affecting command and further comprising:
receiving a second selection of a wireless communication equipment item by the NMS user interface from a second user, wherein the first selected wireless communication equipment item and the second selected wireless communication equipment item are located at the same cell site;
determining a context of the second user of the NMS user interface by the NMS application based on the second selection of the wireless communication equipment item;
developing by the NMS application a second list of NMS commands that are allowed to the second user of the NMS user interface based on the context of the second NMS user;
sending the second list of allowed NMS commands by the NMS application to the NMS user interface;
receiving a fifth selection of one of the second list of allowed NMS commands by the NMS application from the NMS user interface, wherein the fifth selected NMS command is a service affecting NMS command;
determining by the NMS application that the first selected NMS command is on-going; and
responsive to determining that the first selected NMS command is on-going, sending a notification by the NMS application to the NMS user interface indicating that the fifth selected NMS command cannot be executed because it is a service affecting NMS command, indicating that another service affecting NMS command is on-going at the cell site associated with the second selected wireless communication equipment item, and indicating that it is unauthorized to execute two service affecting NMS commands at the same time at the same cell site.

20. The method of claim 12, further comprising the NMS user interface sending the first selection of the wireless communication equipment item and an identity of the user to the NMS application in a JSON object comprising a plurality of key-value pairs.
